(19) United States
(12) Patent Application Publication
(10) Pub. No.: US 2024/0257353 A1
(43) Pub. Date: Aug. 1, 2024

(54) DISPLAY DEVICE AND WEARABLE ELECTRONIC DEVICE

(71) Applicant: Samsung Electronics Co., Ltd., Suwon-si (KR)

(72) Inventor: Jungkyu Kook, Suwon-si (KR)

(21) Appl. No.: 18/416,204

(22) Filed: Jan. 18, 2024

(30) Foreign Application Priority Data
Feb. 1, 2023 (KR) 10-2023-0013882

(51) Int. Cl. G06T 7/11; G02B 27/00; G02B 27/01; G06T 7/194; G06V 10/25; G09G 5/391

(52) U.S. Cl. CPC G06T 7/11; G02B 27/0093; G02B 27/017; G06T 7/194; G06V 10/25; G09G 5/391; G02B 2027/0138; G09G 2340/0407

(57) ABSTRACT

A display device includes a processor configured to generate a region-of-interest image of a current frame based on a background image of the current frame and a line-of-sight region of a user, and a timing controller configured to output the background image and the region-of-interest image to a display panel, wherein the timing controller comprises a buffer storing at least one of the background image and the region-of-interest image, and a reception controller configured to overwrite the region-of-interest image to the buffer based on position information of the region-of-interest image in the background image and to update the at least one of the background image and the region-of-interest image in the buffer.

### CROSS-REFERENCE TO RELATED APPLICATION

This application is based on and claims priority under 35 U.S.C. § 119 to Korean Patent Application No. 10-2023-0013882, filed on Feb. 1, 2023, in the Korean Intellectual Property Office, the disclosure of which is incorporated by reference herein in its entirety.

### BACKGROUND

The inventive concept relates to a display device, and more particularly, to a display device including a processor and a timing controller used to generate a foveated image.

With the recent development of technology, various types of wearable display devices that each may be worn on a user's body have emerged. An extended reality glass (XR glass) device, which is one of the wearable display devices, is a head-mounted device (HMD) that is worn on a user's head and may provide an extended reality (XR) service to the user by providing visual information on a display.

The known XR glass device may display a foveated image focused on a user's region of interest in an image displayed to provide a realistic XR service to the user. The foveated image is generated by tracking the line of sight of a user receiving the XR service and mixing the user's region-of-interest image with a high resolution and a background region image with low resolution. However, when the user's region-of-interest image and the background region image with different resolutions are stored in buffers and the user's region-of-interest image is mixed with the background region image to generate a foveated image, two or more buffers are required and excessive power is consumed, and thus, performance of a display device may degrade.

Accordingly, there is a demand for technology that reduces the number of buffers for storing a user's region-of-interest image and a background region image in a display device and reduces power consumption.

### SUMMARY

The inventive concept provides a display device that generates a foveated image by mixing a user's region-of-interest image with a background image by using one buffer.

According to an aspect of the inventive concept, a display device includes a processor configured to generate a region-of-interest image of a current frame based on a background image of the current frame and a line-of-sight region of a user, and a timing controller configured to output the background image and the region-of-interest image to a display panel, wherein the timing controller includes a buffer storing at least one of the background image and the region-of-interest image, and a reception controller configured to overwrite the region-of-interest image to the buffer based on position information of the region-of-interest image in the background image and to update the at least one of the background image and the region-of-interest image in the buffer.

According to another aspect of the inventive concept, a display device includes a processor configured to generate a region-of-interest image of a current image based on a background image of the current image and a line-of-sight region of a user, a timing controller configured to output the background image and the region-of-interest image to a display panel, and a buffer storing the background image and the region-of-interest image, wherein the timing controller is configured to receive the background image, the region-of-interest image, and position information of the region-of-interest image in the background image from the processor through an interface, write the background image to the buffer, and based on the position information, write the region-of-interest image to a region of a background image corresponding to the position information, and update at least one of the background image and the region-of-interest image in the buffer.

According to another aspect of the inventive concept, a wearable electronic device includes at least one sensor, a processor configured to generate a region-of-interest image based on a background image and a line of sight of a user tracked by using the at least one sensor, and a timing controller, wherein the timing controller stores the background image in a buffer included in the timing controller and overwrites the region-of-interest image to the buffer based on position information of the region-of-interest image in the background image.

### BRIEF DESCRIPTION OF THE DRAWINGS

Embodiments will be more clearly understood from the following detailed description taken in conjunction with the accompanying drawings in which:

FIG. 1 is a block diagram illustrating a display system, according to an example embodiment;

FIG. 2 is a block diagram illustrating a display system, according to an example embodiment;

FIG. 3 is a view illustrating a background image and a region-of-interest image, according to an example embodiment;

FIG. 4 is a diagram illustrating an operation of a processor, according to an example embodiment;

FIG. 5 is a diagram illustrating a method of updating a region-of-interest image, according to an example embodiment;

FIG. 6 is a diagram illustrating a method of updating a background image, according to an example embodiment;

FIG. 7 is a diagram illustrating an operation of a processor, according to an example embodiment;

FIG. 8A is a diagram illustrating a method of updating a region-of-interest image, according to an example embodiment;

FIG. 8B is a diagram illustrating a method of updating a background image and a region-of-interest image, according to an example embodiment;

FIG. 9 is a diagram illustrating an operation of a scaler, according to an example embodiment;

FIG. 10 is a diagram illustrating the time when an image is updated on a display panel, according to an example embodiment;

FIG. 11 is a diagram illustrating a processor and a timing controller, according to an example embodiment;

FIG. 12 is a diagram illustrating an operating method of a display device, according to an example embodiment;

FIG. 13 is a diagram illustrating a wearable device system, according to an example embodiment;

FIG. 14 is a block diagram illustrating a wearable electronic device, according to an example embodiment; and

FIG. 15 is a block diagram illustrating a wearable electronic device, according to an example embodiment.

### DETAILED DESCRIPTION OF THE EMBODIMENTS

Hereinafter, example embodiments of the inventive concept are described in detail with reference to the accompanying drawings. The same reference numerals or reference designators denote the same components or elements throughout the specification and drawings.

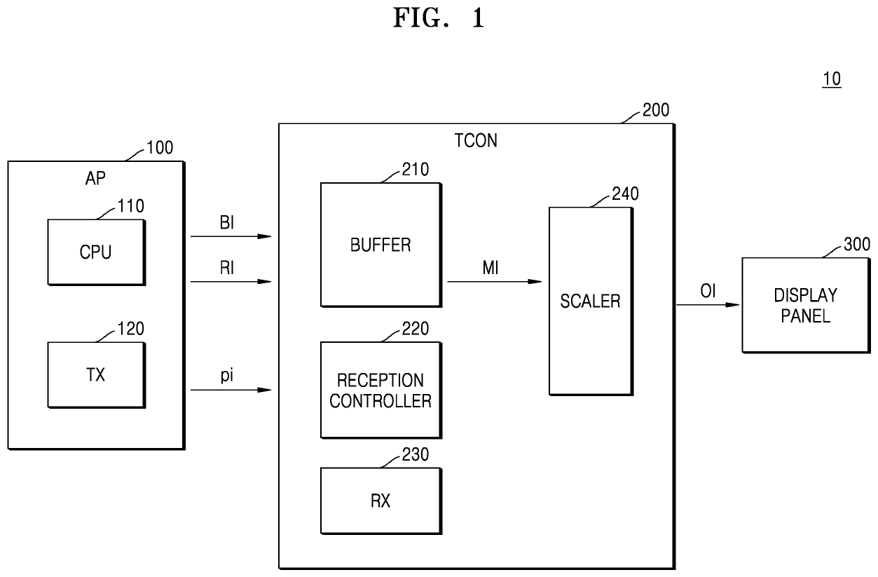

FIG. 1 is a block diagram illustrating a display system according to an example embodiment.

A display system 10 according to an embodiment may be mounted in an electronic device with an image display function. For example, the electronic device may include a smartphone, a tablet personal computer (PC), a portable multimedia player (PMP), a camera, a wearable device, a television, a digital video disk (DVD) player, a refrigerator, an air conditioner, an air purifier, a set-top box, a robot, a drone, various medical devices, a global positioning system (GPS) navigator, a GPS receiver, a vehicle device, furniture, and various measurement devices.

Referring to FIG. 1, the display system 10 may include a processor (for example, an application processor (AP)) 100, a timing controller (TCON) 200, and a display panel 300. According to example embodiments, the display system 10 may further include other general-purpose components in addition to the components illustrated in FIG. 1. In the display system 10, the processor 100 and the timing controller 200 may be referred to as a display device.

The processor 100 may generate a background image BI and a region-of-interest image RI. The background image BI and the region-of-interest image RI may be generated as image data in the form of a data stream and transmitted to the timing controller 200. The processor 100 may generate position information pi indicating a position of the region-of-interest image RI in the background image BI, and may transmit the position information pi to the timing controller 200. The position information pi may include coordinate information indicating a position of the region-of-interest image RI in the background image BI, information of a vertical line and a horizontal line, and so on. The processor 100 may transmit, to the timing controller 200, a control command signal, a clock signal, a synchronization signal, and so on to control the timing controller 200 and the display panel 300.

Referring to FIG. 1, the processor 100 may include a central processing unit (CPU) 110 and a transmission circuit 120. Although FIG. 1 illustrates that the processor 100 includes the CPU 110, the inventive concept is not limited thereto and according to an embodiment, the processor 100 may include a data processing device, such as a graphics processing unit (GPU), a processor, and a microprocessor.

The CPU 110 may control all operations of the processor 100. The CPU 110 may generate the background image BI. The CPU 110 may track the line-of-sight region of a user, and may generate the region-of-interest image RI by tracking the line-of-sight region of a user. In an example embodiment, the processor 100 may transmit the background image BI and the region-of-interest image RI to the timing controller 200.

In an example embodiment, the processor 100 may generate the position information pi. The processor 100 may identify a region of interest of a user by tracking the line of sight of the user The processor 100 may generate the position information pi on the region of interest. For example, the CPU 110 may generate the position information pi. Among regions included in the display panel 300, a region in which the background image BI is located may be a background region and a region in which the region-of-interest image RI is located may be a region of interest. When the background image BI is displayed on the display panel 300, the position information pi may indicate a position of the region of interest in which the region-of-interest image RI is located on the display panel 300.

The processor 100 may compare a region-of-interest image RI of a current frame with a region-of-interest image of a next frame. For example, the CPU 110 may compare the region-of-interest image RI of the current frame with the region-of-interest image of the next frame. The processor 100 may compare the region-of-interest image RI of the current frame with the region-of-interest image of the next frame. The region-of-interest image RI of the current frame may indicate a region-of-interest image stored in a current buffer, and the region-of-interest image of the next frame may indicate a region-of-interest image generated to update the region-of-interest image RI of the current frame.

The processor 100 may generate the position information pi by comparing the region-of-interest image RI of the current frame with the region-of-interest image of the next frame. The position information pi may be generated whenever a region-of-interest image of a next frame is generated to update the region-of-interest image RI of the current frame. For example, when there is a positional difference between the region-of-interest images of the current frame and the next frame, the position information pi may be generated by reflecting the positional difference. However, the inventive concept is not limited thereto, and the position information pi may be generated based on a positional difference, a motion difference, an image difference, and so on between the region-of-interest image RI of the current frame and the region-of-interest image of the next frame.

The processor 100 may compare the region-of-interest image RI of the current frame with the region-of-interest image of the next frame, and may transmit the region-of-interest image of the next frame to the timing controller 200 according to a result of the comparison. When there is a difference between the region-of-interest image of the next frame and the region-of-interest image RI of the current frame, the processor 100 may transmit the region-of-interest image of the next frame to the timing controller 200. The difference between the region-of-interest image of the next frame and the region-of-interest image RI of the current frame may indicate a positional difference, a motion difference, an image difference, and so on. When there is no difference between the region-of-interest image of the next frame and the region-of-interest image RI of the current frame, the processor 100 may not transmit the region-of-interest image of the next frame to the timing controller 200. The processor 100 transmits the region-of-interest image of the next frame to the timing controller 200 only when there is the difference between the region-of-interest image RI of the current frame and the region-of-interest image of the next frame, and thus, power consumption of the display system 10 may be reduced.

The processor 100 may update the background image BI. The processor 100 may generate a background image of the next frame to update the background image BI of the current frame. The processor 100 may compare the background image BI of the current frame with a background image of the next frame, and may transmit the background image of the next frame to the timing controller 200 according to a result of the comparison. The processor 100 may compare the background image BI of the current frame with the background image of the next frame.

When there is a difference between the background image of the next frame and the background image BI of the current frame, the processor 100 may transmit the background image of the next frame to the timing controller 200. The difference between the background image of the next frame and the background image BI of the current frame may indicate a positional difference, a motion difference, an image difference, and so on. When there is no difference between the background image of the next frame and the background image BI of the current frame, the processor 100 may not transmit the background image of the next frame to the timing controller 200. When there is a difference between the background image of the next frame and the background image BI of the current frame, the processor 100 transmits the background image of the next frame to the timing controller 200, and thus, power consumption of the display system 10 may be reduced.

The processor 100 may compare a position of a region-of-interest image RI of the current frame with a position of a region-of-interest image of the next frame. Specifically, the processor 100 may compare a position of the region-of-interest image RI of the current frame with a position of the region-of-interest image of the next frame in the display panel 300. When there is a positional difference between the region-of-interest image RI of the current frame and the region-of-interest image of the next frame, the processor 100 may transmit one of the background image BI of the current frame and the background image of the next frame to the timing controller 200. The processor 100 may transmit the position information pi, which is generated by comparing the region-of-interest image RI of the current frame with region-of-interest image of the next frame, to the timing controller 200.

When there is a positional difference between the region-of-interest image RI of the current frame and the region-of-interest image of the next frame, an existing region of interest corresponding to the region-of-interest image RI of the current frame may not have image data and accordingly, the existing region of interest needs to be filled with the background image BI of the current frame or a background image of the next frame. The existing region of interest may be filled with the background image BI of the current frame or the background image of the next frame based on the position information pi. When the background image BI is not updated, the existing region of interest may be filled with the background image BI. When the background image BI of the current frame is updated to the background image of the next frame, the existing region of interest needs to be filled with the background image of the next frame. Accordingly, one of the background image BI of the current frame and the background image of the next frame may be transmitted to the timing controller 200.

The transmission circuit (TX) 120 may transmit the background image BI, the region-of-interest image RI, and the position information pi to the timing controller 200. The transmission circuit 120 may transmit at least one of the background image BI, the region-of-interest image RI, and the position information pi of the current frame to a reception circuit (RX) 230 of the timing controller 200. In detail, the transmission circuit 120 may transmit at least one of the background image BI, the region-of-interest image RI, and the position information pi to the timing controller 200 according to a set interface. The transmission circuit 120 may transmit a background image of the next frame and a region-of-interest image of the next frame to the reception circuit 230 of the timing controller 200. As used herein, a “set interface” or an “interface” may refer to a mobile industry processor interface (MIPI) interface, an embedded displayport (eDP) interface, a mobile display digital interface (MDDI), a display port (DP) interface, a high definition multimedia interface (HDMI), etc.

For example, the processor 100 may transmit at least one of the background image BI, the region-of-interest image RI, and the position information pi to the timing controller 200 according to a mobile industry processor interface (MIPI) interface and may transmit at least one of the background image BI, the region-of-interest image RI, and the position information pi to the timing controller 200 according to an embedded displayport (eDP) interface, but the processor 100 is not limited to the example described above.

When there is a difference between the region-of-interest image RI of the current frame and the region-of-interest image of the next frame, the transmission circuit 120 may transmit the region-of-interest image of the next frame to the timing controller 200 according to a set interface. The transmission circuit 120 may transmit the region-of-interest image and position information pi of the next frame to the timing controller 200.

When there is a difference between the background image BI of the current frame and a background image of the next frame, the transmission circuit 120 may transmit the background image of the next frame to the timing controller 200 according to a set interface. The transmission circuit 120 may transmit a background image and the position information pi of the next frame to the timing controller 200.

The timing controller 200 may include a buffer 210, a reception controller 220, a reception circuit 230, and a scaler 240. The timing controller 200 may receive the background image BI and the region-of-interest image RI, and may output the background image BI and the region-of-interest image RI to the display panel 300. The timing controller 200 may update at least one of the background image BI and the region-of-interest image RI. Specifically, the timing controller 200 may update the background image BI of the current frame to a background image of the next frame and update the region-of-interest image RI of the current frame to a region-of-interest image of the next frame.

The buffer 210 may store at least one of the background image BI and the region-of-interest image RI. The buffer 210 may store at least a part of the background image BI, and the region-of-interest image RI. The background image BI may be stored in the buffer 210, and the region-of-interest image RI may be stored in a region of interest corresponding to the region-of-interest image RI. The background image BI and the region-of-interest image RI may be stored together in the buffer 210. An image stored in the buffer 210 may be transmitted to the scaler 240 as a mixing image MI.

The mixing image MI may be obtained by mixing the background image BI and the region-of-interest image RI. When there is no background image BI, the region-of-interest image RI may be transmitted as the mixing image MI, and when there is no region-of-interest image RI, the background image BI may be transmitted as the mixing image MI. When at least one of the background image BI and the region-of-interest image RI is updated, the mixing image MI may be output from the buffer 210 by reflecting the updated background image and region-of-interest image.

The reception controller 220 may write an image to the buffer 210. Specifically, the reception controller 220 may control the buffer 210 to write an image to the buffer 210. The reception controller 220 may write the background image to the buffer 210. All image data of the background image may be written to the buffer 210.

In an example embodiment, the reception controller 220 may overwrite the region-of-interest image to the buffer 210 based on the position information pi. The position information pi may represent position information of a region of interest of the background image in which a region-of-interest image is located. The reception controller 220 may overwrite a region-of-interest image to a region corresponding to the position information pi in the background image based on the position information pi. As the reception controller 220 overwrites the region-of-interest image to the region of interest, a background image of the region of interest may be erased from the background image and image data of the region-of-interest image may be stored in the region of interest. For example, the buffer 210 may store a background image excluding the region of interest, and a region-of-interest image of the region of interest. The background image and the region-of-interest image may be stored together in one buffer and accordingly, the number of buffers used in a display device may be reduced and cost required to produce a display device may be reduced. Also, the number of buffers used in the display device may be reduced and accordingly, power consumed to drive the display device may be reduced.

The reception controller 220 may update at least one of the background image BI and the region-of-interest image RI. The reception controller 220 may update the region-of-interest image RI of the current frame. When there is a difference between the region-of-interest image RI of the current frame and a region-of-interest image of the next frame, the timing controller 200 may receive the region-of-interest image of the next frame. The reception controller 220 may update the region-of-interest image RI of the current frame by overwriting the region-of-interest image of the next frame to the buffer 210 based on the position information pi. The reception controller 220 may receive the position information pi which is generated by comparing the region-of-interest image RI of the current frame with the region-of-interest image of the next frame and in which the region-of-interest image of the next frame is in the background image. The position information pi may indicate a position of a region of interest of the region-of-interest image of the next frame. The reception controller 220 may overwrite the region-of-interest image of the next frame to the buffer 210 such that the region-of-interest image of the next frame is in a region of interest of the next frame.

The reception controller 220 may update the background image BI. When there is a difference between the background image BI of the current frame and a background image of the next frame, the timing controller 200 may receive the background image of the next frame. The reception controller 220 may update the background image BI by overwriting the background image of the next frame to the buffer 210 based on the position information pi. The reception controller 220 may update the background image BI by overwriting the background image of the next frame to the buffer 210 such that the background image of the next frame is in a region other than a region of interest.

In an example embodiment, the reception controller 220 may update one of the background image BI of the current frame and the background image of the next frame in the buffer 210 based on the position information pi. When there is a positional difference between the region-of-interest image RI of the current frame and a region-of-interest image of the next frame, the background image BI also needs to be updated. When there is a positional difference between the region-of-interest image RI of the current frame and a region-of-interest image of the next frame and the region-of-interest image of the next frame is updated in the region of interest RI of the current frame, there may be no image data in the existing region of interest that corresponds to the region-of-interest image RI of the current frame. The existing region of interest needs to be updated to the background image BI of the current frame or a background image of the next frame. The existing region of interest may be updated to a background image BI of the current frame or a background image of the next frame based on the position information pi. When the background image BI is not updated, the existing region of interest may be updated to the background image BI. When the background image BI is updated to the background image of the next frame, the existing region of interest needs to be updated to the background image of the next frame.

Because the background image BI and the region-of-interest image RI are mixed and stored in the buffer 210 as the mixing image MI, a separate logic circuit for mixing the background image BI and the region-of-interest image RI is not required, and thus, the degree of freedom in design may be increased and the size of a display device may be reduced. When at least one of the background image and the region-of-interest image is updated, the updated background image and region-of-interest image may be mixed and stored in the buffer 210 as the mixing image MI.

The reception circuit 230 may receive the background image BI, the region-of-interest image RI, and the position information pi from the processor 100. The reception circuit 230 may receive at least one of the background image BI, the region-of-interest image RI, and the position information pi from the transmission circuit 120. The reception circuit 230 may receive at least one of the background image BI, the region-of-interest image RI, and the position information pi from the processor 100 according to a set interface. The reception circuit 230 may be configured with the same interface as the transmission circuit 120. Although the reception controller 220 and the reception circuit 230 are illustrated as separate logic blocks in FIG. 1, according to example embodiments, the reception controller 220 and the reception circuit 230 may be implemented as one logic block. The reception circuit 230 may receive a background image of the next frame and a region-of-interest image of the next frame from the processor 100.

When there is a difference between the region-of-interest image RI of the current frame and the region-of-interest image of the next frame, the reception circuit 230 may receive the region-of-interest image of the next frame from the processor 100 according to a set interface. The reception circuit 230 may receive the region-of-interest image and position information pi of the next frame from the processor 100.

When there is a difference between the background image BI of the current frame and the background image of the next frame, the reception circuit 230 may receive the background image of the next frame from the processor 100 according to a set interface. The reception circuit 230 may receive a background image and the position information pi of the next frame from the processor 100.

The transmission circuit 120 and the reception circuit 230 may be configured for communication (e.g., transmission to and/or from) according to any wired or wireless communication system including one or more Ethernet, telephone, cable, power-line and fiber optic systems and/or one or more code division multiple access (CDMA or CDMA2000) communication systems; a frequency division multiple access (FDMA) system; an orthogonal frequency division multiplexing (OFDM) access system; time division multiple access (TDMA) such as global system for mobile communications (GSM); general packet radio service (GPRS) or enhanced data GSM environment (EDGE); a terrestrial trunked radio (TETRA) mobile telephone system; a wideband code division multiple access (WCDMA) system; a high data rate first generation evolution data only (1×EV-DO) or a 1×EV-DO gold multicast system; an institute of electrical and electronics engineers (IEEE) 802.18 system; a digital multimedia broadcasting (DMB) system; a digital video broadcast handheld (DVB-H) system; or a wireless system including different types of data communication between two or more devices.

The scaler 240 may receive the mixing image MI. The scaler 240 may perform a scaling operation such that the mixing image MI is displayed on the display panel 300. The scaling operation may refer to an operation of changing the size of an image to fit the size of the display panel 300. The scaler 240 may generate an output image OI that is a foveated image by performing the scaling operation on the mixing image MI.

Specifically, the scaler 240 may expand or contract the mixing image MI in the horizontal direction and/or may expand or contract the mixing image MI in the vertical direction. For example, the scaler 240 may generate the output image OI by scaling up the mixing image MI. Because the scaler 240 performs the scaling operation on the mixing image MI, a background image and a region-of-interest image may be scaled up or scaled down.

The display panel 300 may display an image based on the output image OI. The display system 10 may display the output image OI to a user on the display panel 300. The display panel 300 is a display unit on which an actual image is displayed and may be a display device, which receives an electrically transmitted image signal and displays a two-dimensional image, such as a thin film transistor-liquid crystal display (TFT-LCD), an organic light emitting diode (OLED) display, a field emission display, and a plasma display panel (PDP). The display panel 300 may be implemented by a flat panel display or a flexible display panel of another type.

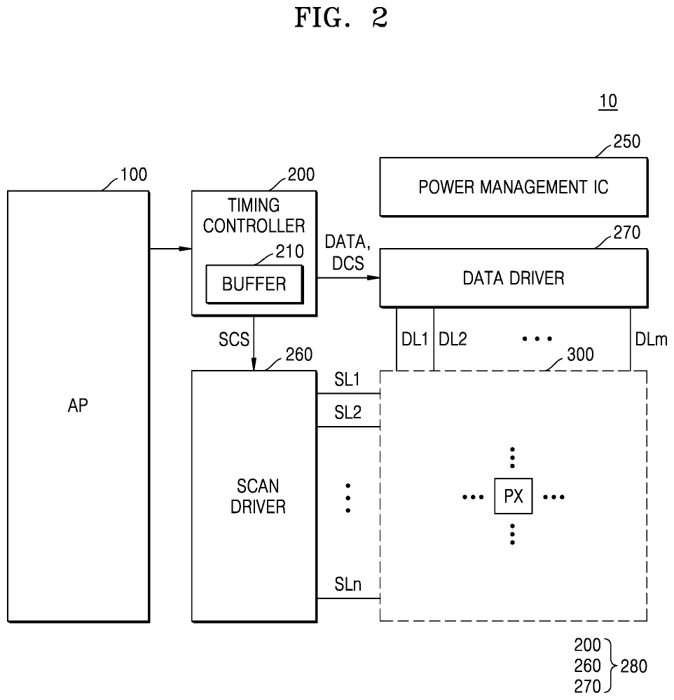

FIG. 2 is a block diagram illustrating a display system according to an example embodiment. The descriptions previously given with reference to FIG. 1 are not repeated.

Referring to FIG. 2, a display system 10 according to the inventive concept includes an application processor (AP) (hereinafter referred to as a processor) 100, a display panel 300 including a plurality of pixels PX, a timing controller 200, a scan driver 260, a data driver 270, and a power management integrated circuit (IC) (PMIC) 250. Herein, the display system 10 may be mounted in a wearable display device (for example, wearable glasses).

In an example embodiment, the processor 100 may identify a user's region of interest by tracking the user's line of sight. The user's region of interest may refer to a region where the user's line of sight stays among a plurality of regions included in the display panel 300. The user's region of interest may be a region of a background image in which a region-of-interest image is located. The processor 100 may track the user's line-of-sight region (or the user's region of interest) by using at least one sensor and generate and process a region-of-interest image based on the tracked region of interest of the user. The processor 100 may generate a background image. The processor 100 may transmit position information pi, the background image BI, and a region-of-interest image RI to the timing controller 200.

The timing controller 200 may store at least one of the background image BI and the region-of-interest image RI in the buffer 210. The timing controller 200 may store the background image BI and the region-of-interest image RI in the buffer 210 based on the position information pi. A mixing image MI may be output from the buffer 210, and the mixing image MI may be scaled up to generate an output image OI that is a foveated image. The timing controller 200 may provide the data driver 270 with a data value DATA for the output image OI, a data control signal DCS, and so on. The timing controller 200 may provide a clock signal, a scan control signal SCS, and so on to the scan driver 260.

The data driver 270 may generate data voltages to be provided to data lines DL1 to DLm by using the data value DATA and the data control signal DCS received from the timing controller 200. Here, m is a natural number greater than 1.

The scan driver 260 may receive the scan control signal SCS (including a clock signal, a scan start signal, and so on) from the timing controller 200, and may generate scan signals to be provided to scan lines SLI to SLn. Here, n is a natural number greater than 1.

In an example embodiment, the display panel 300 may include a light-receiving layer, a light-emitting layer, and a transparent layer which are stacked in the vertical direction. Here, the light-receiving layer may include at least one photodetector for measuring a reflection pattern, and the light-emitting layer may be over the light-receiving layer and include a plurality of pixels PX. The transparent layer may be over the light-emitting layer in the display panel 300 and may be formed of a stretchable material.

The display panel 300 includes the plurality of pixels (for example, a plurality of self-light emitting elements) PX. The plurality of pixels PX may be respectively connected to corresponding data lines and scan lines.

In an example embodiment, the plurality of pixels PX may include red pixels emitting red light, blue pixels emitting blue light, and green pixel emitting green light. In another example, the plurality of pixels PX may include white pixels, cyan pixels, magenta pixels, and yellow pixels instead of the red pixels, the green pixels, and the blue pixels.

A circuit including at least one of the timing controller 200, the scan driver 260, and the data driver 270 may be referred to as a display driver IC 280. The display driver IC 280 may be provided in the form of an IC.

The power management IC 250 may receive external power (for example, a battery voltage). In one example, the power management IC 250 may generate a voltage to be supplied to the display driver IC 280 based on the external voltage.

In an example embodiment, the power management IC 250 may generate a voltage to be supplied to the timing controller 200 of the display driver IC 280 or the processor 100. The power management IC 250 may generate a voltage for generating a foveated image and supply the voltage to the timing controller 200 or the processor 100.

In an example embodiment, the power management IC 250 may include at least one regulator. In one example, the at least one regulator may generate output voltages having various voltage levels from a voltage supplied from an external power supply. In one example, the at least one regulator may be configured as a controller or included in a controller. In one example, the at least one regulator may include a buck-converter but is not limited thereto. For example, the at least one regulator may include at least one of a buck-boost converter, a boost converter, and a Ćuk converter.

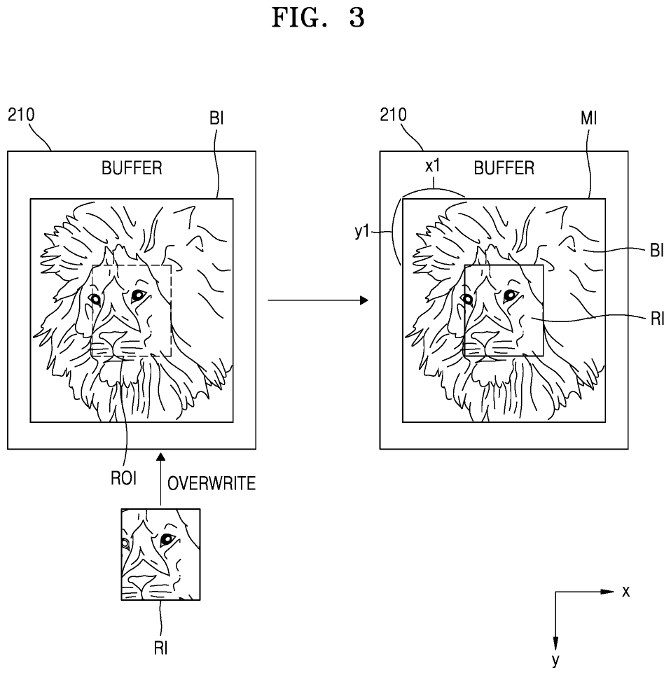

FIG. 3 is a view illustrating a background image and a region-of-interest image according to an example embodiment. In FIG. 3, image data stored in the buffer 210 may be changed to an image and represented as a background image BI and a region-of-interest image RI. Descriptions previously given with reference to FIGS. 1 and 2 are not repeated. Background images and region-of-interest images of all frames may be stored in the buffer 210, similar to the method described with reference to FIG. 1.

Referring to FIG. 3, a timing controller (e.g., the timing controller 200 of FIG. 1) may store the background image BI in the buffer 210. The timing controller may overwrite the region-of-interest image RI to the buffer 210 based on position information (e.g., position information pi). The position information may refer to position information of a region of interest ROI of the background image BI in which the region-of-interest image RI is located. The timing controller may determine a position of the region of interest ROI to which the region-of-interest image RI is written based on the position information.

The region-of-interest image RI may be overwritten to the region of interest ROI of the background image BI to generate the mixing image MI. The region-of-interest image RI may be written to the region of interest ROI of the mixing image MI, and the background image BI may be written to a region other than the region of interest ROI.

The position information may indicate a position of the region of interest ROI. In an example embodiment, the position information may indicate positions of four vertices of a rectangle constituting the region of interest ROI. For example, the region-of-interest image RI may be written to the buffer 210 from a position that is separated by x1 in the x direction and by y1 in the y direction from a top left pixel of the background image BI.

In an example embodiment, the resolution of the background image BI may be different from the resolution of the region-of-interest image RI. The resolution of the background image BI may be lower than the resolution of the region-of-interest image RI. For example, the region-of-interest image RI may be at a high resolution, and the background image BI may be at a low resolution. The resolution of the region-of-interest image RI tracking a user's line of sight is increased, and thus, power for generating the region-of-interest image RI and the background image BI may be reduced. However, the inventive concept is not limited thereto, and the resolution of the background image BI may be the same as the resolution of the region-of-interest image RI.

The mixing image MI may be generated by overwriting the region-of-interest image RI to the region of interest ROI of the background image BI. Even when there is no logic for mixing the background image BI and the region-of-interest image RI, the mixing image MI may be generated and cost required to produce a display device may be reduced.

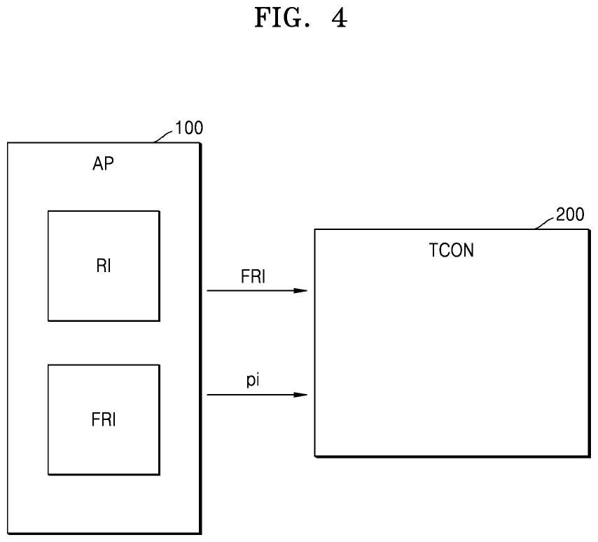

FIG. 4 is a diagram illustrating an operation of a processor according to an example embodiment. A processor 100 and a timing controller (TCON) 200 of FIG. 4 respectively correspond to the processor 100 and the timing controller 200 of FIG. 1 and accordingly, descriptions previously given with reference to FIG. 1 are not repeated.

Referring to FIG. 4, the processor 100 may generate a region-of-interest image RI. The processor 100 may generate a region-of-interest image FRI for updating the region-of-interest image RI. The region-of-interest image FRI may refer to a region-of-interest image of a next frame, and the region-of-interest image RI may refer to a region-of-interest image of a current frame.

The processor 100 may compare the region-of-interest image RI with the region-of-interest image FRI. The processor 100 may compare the region-of-interest image RI with the region-of-interest image FRI and transmit the region-of-interest image FRI to the timing controller 200 according to a result of the comparison. The processor 100 may compare a positional difference, a motion difference, an image difference, and so on of the region-of-interest image FRI with a positional difference, a motion difference, an image difference, and so on of the region-of-interest image RI.

When there is a difference between the region-of-interest image FRI and the region-of-interest image RI, the processor 100 may transmit the region-of-interest image FRI to the timing controller 200. The processor 100 may transmit the region-of-interest image FRI and position information pi to the timing controller 200. In an example embodiment, when there is a difference between the region-of-interest image FRI and the region-of-interest image RI but there is no positional difference, the processor 100 may transmit the region-of-interest image FRI and the position information pi to the timing controller 200. The timing controller 200 may update the region-of-interest image RI to a region-of-interest image FRI by overwriting the region-of-interest image FRI to a buffer (e.g., the buffer 210 of FIG. 1) based on the position information pi.

The processor 100 may generate the position information pi by comparing the region-of-interest image RI with the region-of-interest image FRI. The position information pi may be generated whenever the region-of-interest image FRI of the next frame for updating the region-of-interest image RI is generated. The position information pi may be generated based on a positional difference, a motion difference, an image difference, and so on between the region-of-interest image RI and the region-of-interest image FRI.

When there is no difference between the region-of-interest image FRI and the region-of-interest image RI, the processor 100 may not transmit the region-of-interest image FRI to the timing controller 200. When there is a difference between the region-of-interest image FRI and the region-of-interest image RI, the processor 100 may transmit the region-of-interest image FRI to the timing controller 200 to be updated, and thus, power consumption of a display device may be reduced.

Although not illustrated in FIG. 4, the processor 100 may generate a background image BI. The processor 100 may generate a background image of a next frame for updating the background image BI.

The processor 100 may compare a background image BI of the current frame with a background image of the next frame. The processor 100 may compare the background image BI of the current frame with the background image of the next frame and transmit the background image of the next frame to the timing controller 200 according to a result of the comparison. When there is a difference between the background image BI of the current frame and the background image of the next frame, the processor 100 may transmit the background image of the next frame to the timing controller 200. The timing controller 200 may update the current background image BI to the background image of the next frame by overwriting the background image of the next frame to the buffer based on the position information pi. The timing controller 200 may overwrite the background image of the next frame to a region other than the region of interest based on the position information pi.

When there is no difference between the background image BI of the current frame and the background image of the next frame, the processor 100 may not transmit the background image of the next frame to the timing controller 200. When there is a difference between the background image of the current frame and the background image of the next frame, the processor 100 may transmit the background image FRI of the next frame to the timing controller 200 to be updated, and thus, power consumption of a display device may be reduced.

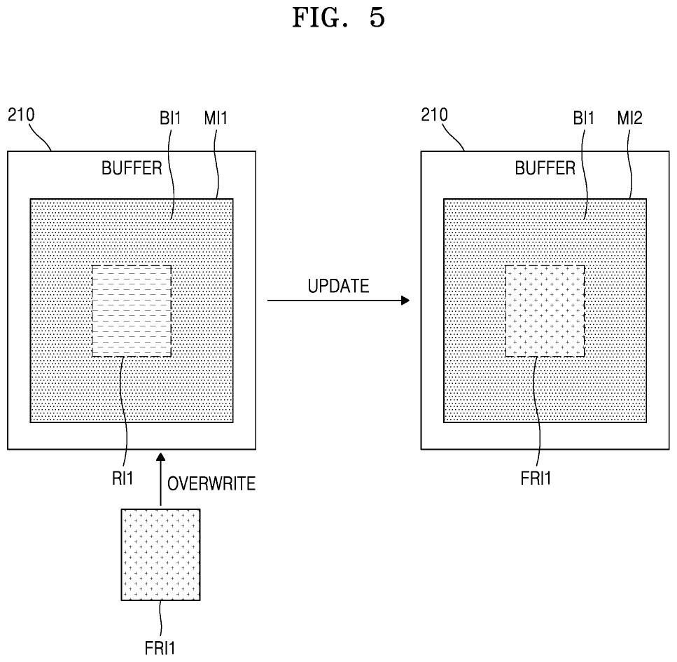

FIG. 5 is a diagram illustrating a method of updating a region of interest image, according to an example embodiment. Descriptions previously given with reference to FIGS. 1 to 4 are not repeated.

Referring to FIG. 5, a background image BI1 may be stored in the buffer 210. A region-of-interest image RI1 may be overwritten to a region of interest of the background image BI1 in the buffer 210. The background image BI1 may refer to a background image of a current frame, the region-of-interest image RI1 may refer to a region-of-interest image of the current frame, and a region-of-interest image FRI1 may refer to a region-of-interest image of a next frame. In FIG. 5, it is assumed that there is a motion difference, an image difference, and so on between the region-of-interest image RI1 and the region-of-interest image FRI1 but there is no positional difference therebetween.

A timing controller (e.g., timing controller 200) may receive the region-of-interest image FRI1 and position information (e.g., position information pi). The timing controller may update the region-of-interest image RI1 based on the position information. The timing controller may overwrite the region-of-interest image FRI1 to the same region of interest as a region of interest of the region-of-interest image RI1. An image in the region of interest may be updated from the region-of-interest image RI1 to the region-of-interest image FRI1.

The mixing image MI2 may be generated by overwriting the region-of-interest image FRI1 to the buffer 210. A region of interest of the mixing image MI2 may include the region-of-interest image FRI1, and a region other than the region of interest may include the background image BI1.

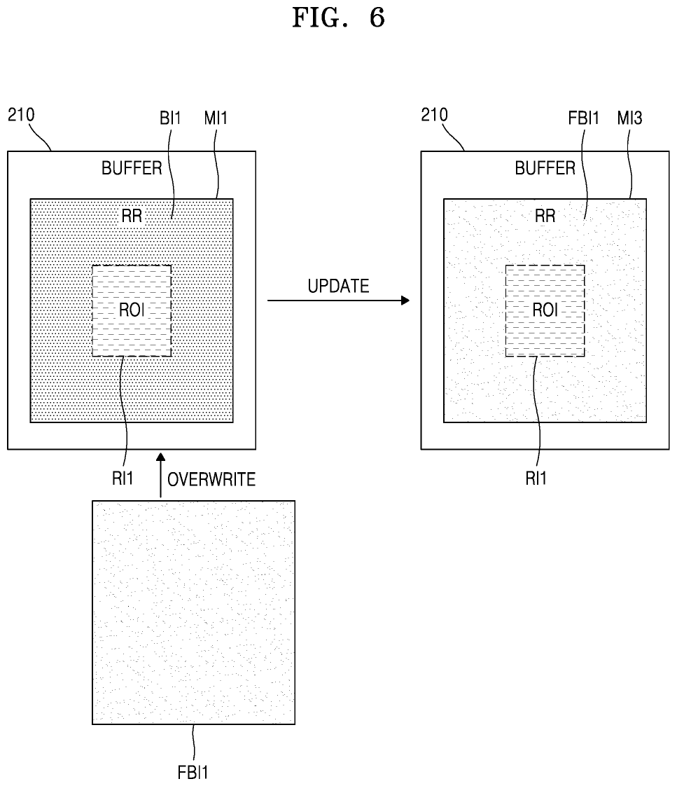

FIG. 6 is a diagram illustrating a method of updating a background image, according to an example embodiment. Descriptions previously given with reference to FIGS. 1 to 5 are not repeated.

Referring to FIG. 6, a background image BI1 may be stored in the buffer 210. A region-of-interest image RI1 may be overwritten to a region of interest ROI of the background image BI1 in the buffer 210 and stored in the buffer 210 as a mixing image MI1. The background image BI1 may refer to a background image of a current frame, a region-of-interest image RI1 may refer to a region-of-interest image of the current frame, and a background image FBI1 may refer to a background image of a next frame. In FIG. 5, it is assumed that there is a difference between the background image BI1 and the background image FBI1.

A timing controller (e.g., timing controller 200) may receive the background image FBI1 and position information (e.g., position information pi). The timing controller may update the background image BI1 based on the position information. The timing controller may determine a region RR excluding a region of interest ROI based on the position information.

The timing controller may overwrite the background image FBI1 to the region RR of the background image BI1 excluding the region of interest ROI. An image in the region RR may be updated from the background image BI1 to the background image FBI1.

A mixing image MI3 may be generated by overwriting the background image FBI1 to the buffer 210. The region of interest ROI of the mixing image MI3 may include the region-of-interest image RI1, and the region RR excluding the region of interest ROI may include the background image FBI1. Because the background image FBI1 in the region RR other than the region of interest ROI is updated, the region-of-interest image RI1 of the region of interest ROI may be maintained. After the background image FBI1 is overwritten to the region of interest ROI, the region-of-interest image RI1 may not be written to the buffer 210 again, and thus, the time required to generate the mixing image MI3 may be reduced.

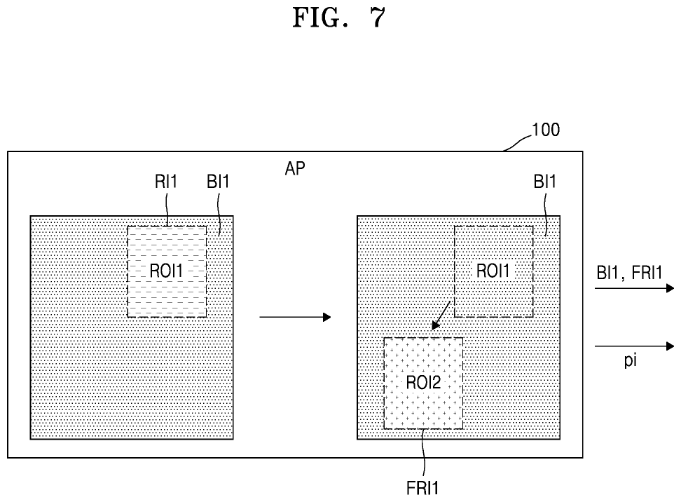

FIG. 7 is a diagram illustrating an operation of a processor, according to an example embodiment. Descriptions previously given with reference to FIGS. 1 to 6 are not repeated.

In an example embodiment, a processor 100 may compare a position of a region-of-interest image RI1 with a position of a region-of-interest image FRI1. The region-of-interest image RI1 may refer to a region-of-interest image of a current frame, and the region-of-interest image FRI1 may refer to a region-of-interest image of a next frame. Specifically, the processor 100 may compare a position of the region-of-interest image RI1 with a region of interest of each of the region-of-interest images FRI1 on the display panel. The processor 100 may compare a position of a region of interest ROI1 of the region-of-interest image RI with a region of interest ROI2 of the region-of-interest image FRI1.

When there is a positional difference between the region-of-interest image RI1 and the region-of-interest image FRI1, the processor 100 may transmit one of the background image BI1 of the current frame and the background image of the next frame (e.g., background image FBI1) to a timing controller (e.g., timing controller 200). Because there is a positional difference between the region of interest ROI1 and the region of interest ROI2, the processor 100 may transmit one of the background image BI1 of the current frame and the background image of the next frame to the timing controller. The processor 100 may transmit position information pi generated by comparing the region-of-interest image RI1 with the region-of-interest image FRI1 to the timing controller.

When there is a positional difference between the region-of-interest image RI1 and the region-of-interest image FRI1 and a background image of a next frame (e.g., background image FBI1) that is different from the background image BI1 is generated before a point in time when the region-of-interest image FRI1 is to be transmitted to the timing controller, the processor 100 may transmit the background image of the next frame to the timing controller. The processor 100 may transmit the region-of-interest image FRI1 to the timing controller.

When there is a positional difference between the region-of-interest image RI1 and the region-of-interest image FRI and the background image of the next frame (e.g., background image FBI1) having no difference from the background image BI1 of the current frame is generated or the background image of the next frame is not generated before a point in time when the region-of-interest image FRI is to be transmitted to the timing controller, the processor 100 may transmit the background image BI1 of the current frame to the timing controller. FIG. 7 illustrates a case in which a background image BI1 of a current frame is transmitted. A processor 100 may transmit a region-of-interest image FRI1 to a timing controller.

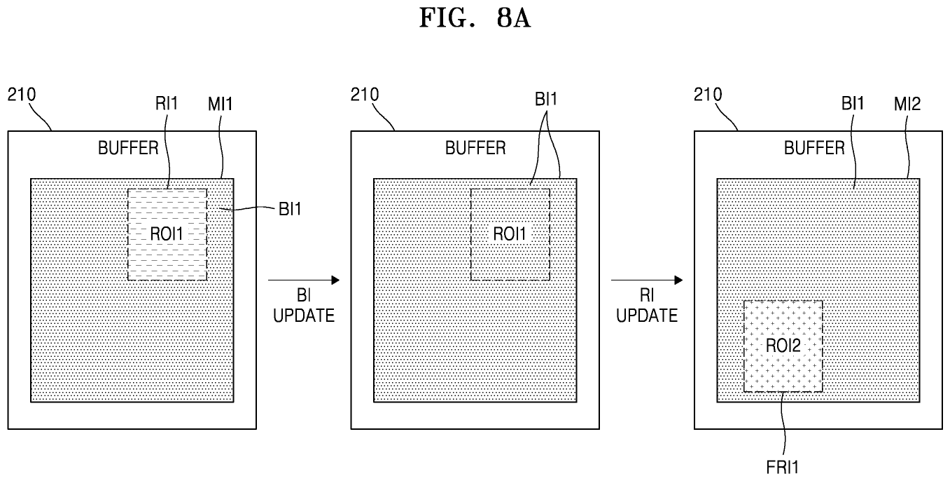

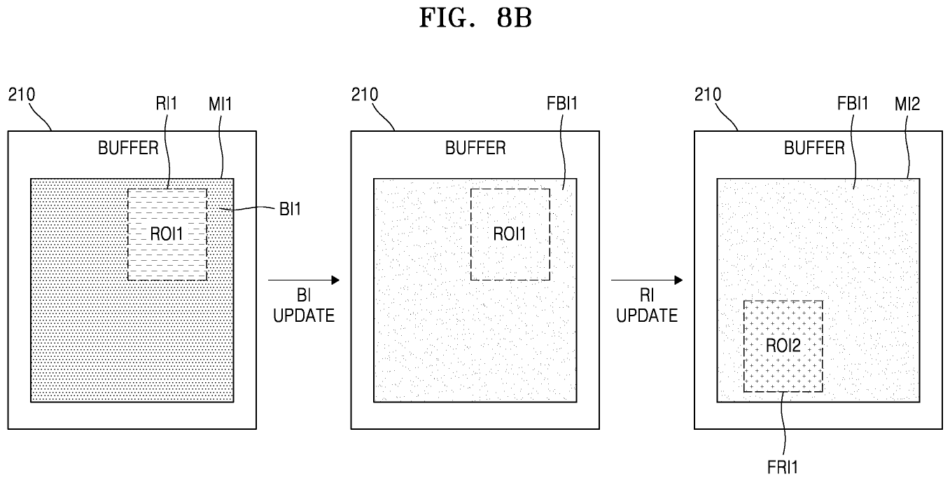

FIG. 8A is a diagram illustrating a method of updating a region-of-interest image according to example embodiments. Descriptions previously given with reference to FIG. 7 are not repeated.

Referring to FIG. 8A, a background image BI1 may be stored in the buffer 210. A region-of-interest image RI1 may be overwritten to a region of interest ROI1 of the background image BI1 in the buffer 210. The region-of-interest image RI1 may refer to a region-of-interest image of a current frame, the background image BI1 may refer to a background image of the current frame, and a region-of-interest image FRI1 may refer to a region-of-interest image of a next frame. The background image BI1 in the buffer 210 may be overwritten to the region of interest ROI1. In FIG. 8A, it is assumed that there is a positional difference between the region-of-interest image RI1 and the region-of-interest image FRI1.

A timing controller (e.g., the timing controller 200 of FIG. 1) may first update the background image BI1 and then update the region-of-interest image RI1. However, the inventive concept is not limited thereto. The timing controller may receive the background image BI1. The timing controller may update the background image BI1 based on position information (e.g., position information pi). The timing controller may also update the ROI1 to the background image BI1 by overwriting the background image BI1 to the buffer 210.

In an example embodiment, the timing controller may update the background image BI1 of the buffer 210 to a region other than a region of interest ROI2 corresponding to the region of interest image FRI1 based on the position information. The background image BI1 may be updated in the region other than the region of interest ROI2, and the existing region of interest ROI1 may be updated to the background image BI1.

The timing controller may receive the region of interest image FRI1 and the position information. The timing controller may update the region-of-interest image RI1 based on the position information. The timing controller may overwrite the region-of-interest image FRI1 to the region of interest ROI2. The region of interest ROI1 may be changed to the region of interest ROI2. The region-of-interest image RI1 in the region of interest ROI1 may be updated to the region-of-interest image FRI1 in the region of interest ROI2.

A mixing image MI2 may be generated by overwriting the region-of-interest image FRI1 to the buffer 210. The region of interest ROI2 of the mixing image MI2 may include the region-of-interest image FRI1, and the region other than the region of interest ROI2 may include the background image BI1.

FIG. 8B is a diagram illustrating a method of updating a background image and a region-of-interest image according to example embodiments. Descriptions previously given with reference to FIGS. 1 to 8A are not repeated.

Referring to FIG. 8B, a background image BI1 may be stored in a buffer 210. A region-of-interest image RI1 may be overwritten to a region of interest ROI1 of the background image BI1 in the buffer 210. The region-of-interest image RI1 may refer to a region-of-interest image of a current frame, the background image BI1 may refer to a background image of the current frame, a region-of-interest image FRI1 may refer to a region-of-interest image of a next frame, and a background image FBI1 may refer to a background image of the next frame. The background image BI1 in the buffer 210 may be overwritten to the region of interest ROI1. In FIG. 8B, it is assumed that there is a positional difference between the region-of-interest image RI1 and the region-of-interest image FRI1.

A timing controller (e.g., timing controller 200) may update the background image BI1. The timing controller may receive the background image FBI1. The timing controller may update the background image BI1 to the background image FBI1 based on position information (e.g., position information pi). The timing controller may also update the region of interest ROI1 to the background image FBI1 by overwriting the background image FBI1 to the buffer 210.

In an example embodiment, the timing controller may update the background image FBI1 to a region other than a region of interest ROI2 corresponding to the region-of-interest image FRI1 based on the position information. The background image FBI1 may be updated in the region other than the region of interest ROI2, and the existing region of interest ROI1 may be updated to the background image FBI1.

The timing controller may update the region-of-interest image RI1 based on the position information. The timing controller may overwrite the region-of-interest image FRI1 to the region-of-interest ROI2. A mixing image MI2 may be generated by overwriting the region-of-interest image FRI1 to the buffer 210. The region of interest ROI2 of the mixing image MI2 may include the region-of-interest image FRI1, and the region other than the region of interest ROI2 may include the background image FBI1.

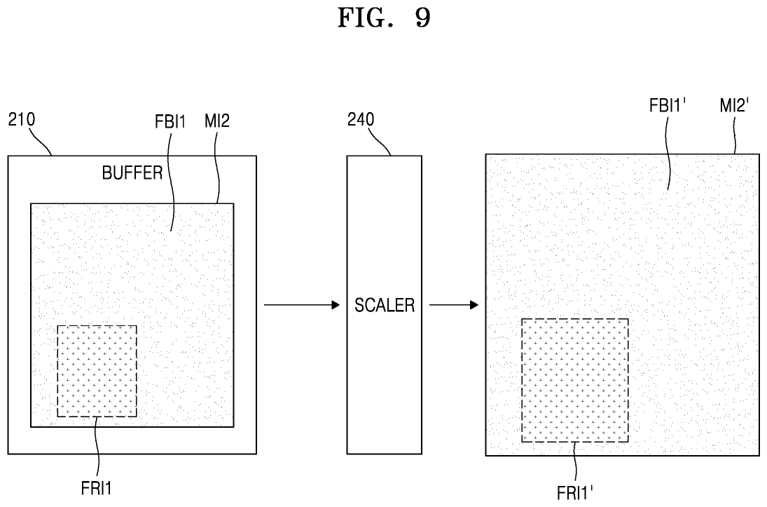

FIG. 9 is a diagram illustrating an operation of a scaler, according to an example embodiment. A buffer 210 and a scaler 240 of FIG. 9 respectively correspond to the buffer 210 and the scaler 240 of FIG. 1 and accordingly, descriptions previously given with reference to FIGS. 1 to 8B are not repeated.

The scaler 240 may receive a mixing image MI2 from the buffer 210. The mixing image MI2 may be obtained by mixing a background image FBI1 with a region-of-interest image FRI1.

The scaler 240 may perform a scaling operation to display the mixing image MI2 on a display panel (e.g., the display panel 300 of FIG. 1). The scaling operation may refer to an operation of changing the size of an image to be fitted to the size of a display panel. The scaler 240 may perform a scaling operation on the mixing image MI2 to generate an output image MI2′ that is a foveated image.

The scaler 240 may expand or contract the mixing image MI2 in the horizontal direction and/or may expand or contract the mixing image MI2 in the vertical direction. Because the scaler 240 performs a scaling operation on the mixing image MI2, the background image FBI1 and the region-of-interest image FRI1 may be scaled up or scaled down. For example, the scaler 240 may generate the output image MI2′ by scaling up the mixing image MI2. Because the mixing image MI2 is scaled up, the background image FBI1 may be scaled up to the background image FBI1′ and the region-of-interest image FRI1 may be scaled up to the region-of-interest image FRI1′.

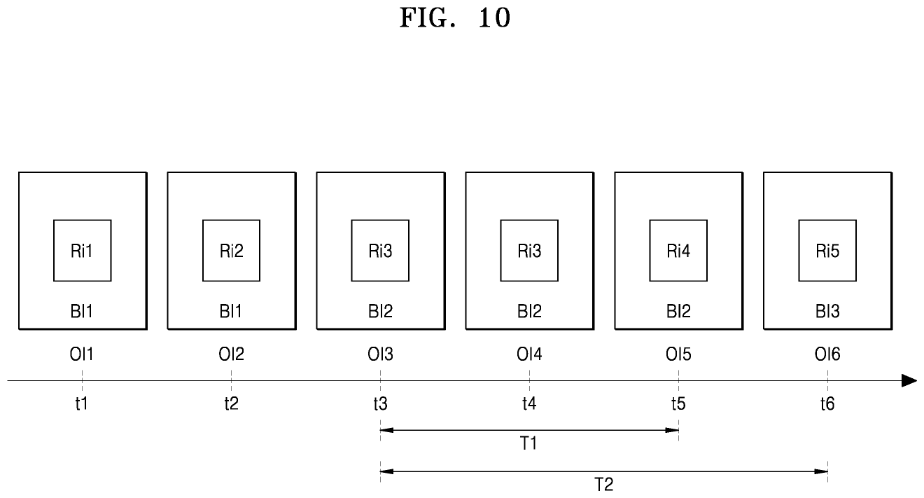

FIG. 10 is a diagram illustrating the time when an image is updated on a display panel, according to an example embodiment.

Referring to FIGS. 10 and 1 together, an output image OI may be displayed on the display panel 300. The output image OI may be displayed on the display panel 300 according to an internal clock of the timing controller 200. The output image OI may include a background image BI and a region-of-interest image RI.

In an example embodiment, the time when the background image BI is updated on the display panel 300 may be different from the time when the region-of-interest image RI is updated on the display panel 300. Because the time when the background image BI and the region-of-interest image RI are generated by the processor 100 are different from each other, the time when the background image BI is updated on the display panel 300 may be different from the time when the region-of-interest image RI is updated on the display panel 300.

For example, an output image OI1 may be displayed on the display panel 300 at a first point in time t1. The output image OI1 may include a region-of-interest image RI1 and a background image BI1. At a second point in time t2, an output image OI2 may be displayed on the display panel 300. The output image OI2 may include a region-of-interest image RI2 and a background image BI1. At the second point in time t2, the region-of-interest image RI1 is updated to the region-of-interest image RI2, but the background image BI1 may not be updated.

In an example embodiment, the time for updating the region-of-interest image RI on the display panel 300 may be less than the time for updating the background image BI on the display panel 300. For example, an output image OI3 may be displayed on the display panel 300 at a third point in time t3. The output image OI3 may include a background image BI2 and a region-of-interest image RI3. An output image 015 may be displayed on the display panel 300 at a fifth point in time t5. The output image 015 may include the background image BI2 and a region-of-interest image RI4. The region-of-interest image RI3 may be updated to the region-of-interest image RI4 at a fifth point in time t5 after a first period T1 from the third point in time t3. For example, at a fourth point in time t4, the output image OI4 may include the background image BI2 and the region-of-interest image RI3.

An output image 016 may be displayed on the display panel 300 at a sixth point in time t6. The output image 016 may include a background image BI3 and a region-of-interest image RI5. The region-of-interest image RI4 may be updated to the region-of-interest image RI5 at the sixth point in time t6. The background image BI2 may be updated to the background image BI3 at the sixth point in time t6 after a second period T2 from the third point in time t3. The first period T1 may be less than the second period T2.

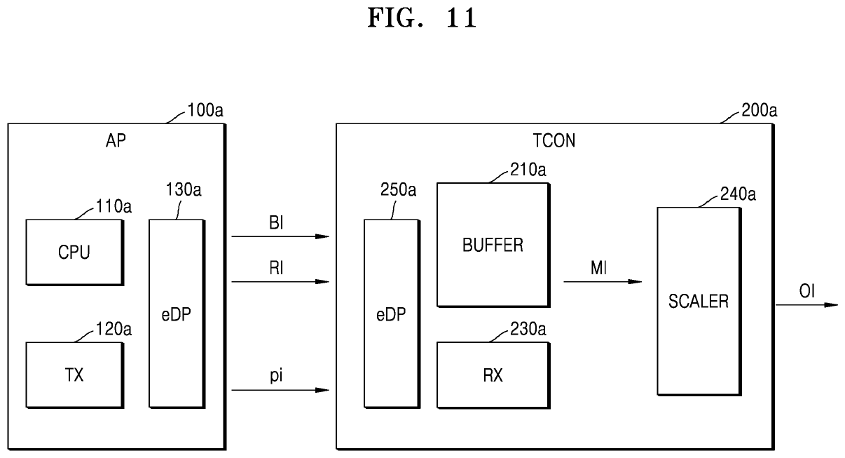

FIG. 11 is a diagram illustrating a processor and a timing controller according to an example embodiment. A processor 100a, a CPU 110a, a transmission circuit 120a, a timing controller 200a, a buffer 210a, a reception circuit 230a, and a scaler 240a of FIG. 11 respectively correspond to the processor 100, the CPU 110, the transmission circuit 120, the timing controller 200, the buffer 210, the reception circuit 230, and the scaler 240 of FIG. 1 and accordingly, redundant descriptions thereof are not repeated.

Referring to FIG. 11, an interface of the processor 100a and an interface of the timing controller 200a may respectively be an embedded displayport (eDP) interface 130a and an eDP interface 250a. The processor 100a may transmit at least one of a background image BI, a region-of-interest image RI, and position information pi to the timing controller 200a through the eDP interface 130a.

The timing controller 200a may receive at least one of the background image BI, the region-of-interest image RI, and the position information pi through the eDP interface 250a. The timing controller 200a may write the background image BI to the buffer 210a and write the region-of-interest image RI to a region of interest of the background image BI corresponding to the position information pi, based on the position information pi.

The timing controller 200a may write the background image BI to the buffer 210a by using panel self-refresh (PSR) technologies of the eDP interfaces 130a and 250a and overwrite the region-of-interest image RI to a region of interest of the buffer 210a. In an example embodiment, the timing controller 200a may not include a reception controller (e.g., the reception controller 220 of FIG. 1).

The timing controller 200a may write the background image BI, overwrite the region-of-interest image RI to the buffer 210a based on the position information pi, and update at least one of the background image BI and the region-of-interest image RI. Specifically, the reception circuit 230a may receive the background image BI, the region-of-interest image RI, and the position information pi from the processor 100a through the eDP interface 250a, write the background image BI to the buffer 210a, and overwrite the region-of-interest image RI based on the position information pi.

When receiving the position information pi through the eDP interface 250a, the reception circuit 230a may update a region-of-interest image of a next frame (e.g., region-of-interest image FRI) in the buffer 210a based on the position information pi. When there is a difference between the region-of-interest image RI of a current frame and a region-of-interest image of a next frame, the reception circuit 230a may receive the region-of-interest image of the next frame. The reception circuit 230a may update the region-of-interest image RI of the current frame by overwriting the region-of-interest image of the next frame to the buffer 210a based on the position information pi.

The reception circuit 230a may update the background image BI. When there is a difference between the background image BI of a current frame and a background image of a next frame (e.g., background image FBI), the reception circuit 230a may receive the background image of the next frame. The reception circuit 230a may update the background image BI of the current frame by overwriting the background image of the next frame to the buffer 210a based on the position information pi.

When there is a positional difference between the region-of-interest image RI of the current frame and the region-of-interest image of the next frame, the reception circuit 230a may update the background image BI of the current frame. The reception circuit 230a may update one of the background image BI and the background image of the next frame in the buffer 210a based on the position information pi.

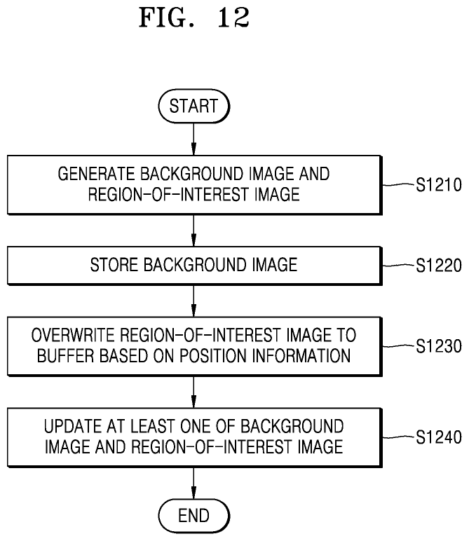

FIG. 12 is a diagram illustrating an operating method of a display device, according to an example embodiment. Descriptions previously given with reference to FIGS. 1 to 11 are not repeated.

In operation S1210, a display device may generate a background image (e.g., background image BI) and a region-of-interest image (e.g., region-of-interest image RI). The background image may refer to an image displayed in most parts of a region displayed on a display panel. The region-of-interest image may refer to an image displayed in a region of interest of a user. The display device may track the region of interest of the user by using at least one sensor and generate a region-of-interest image based on the tracked region of interest of the user.

The display device may compare a region-of-interest image of a current frame with a region-of-interest image of a next frame (e.g., region-of-interest FRI). The display device may generate the region-of-interest image of the next frame to update the region-of-interest image of the current frame. The display device may generate position information (e.g., position information pi) by comparing the region-of-interest image of the current frame with the region-of-interest image of the next frame. The position information may be generated whenever the region-of-interest image of the next frame for updating the region-of-interest image is generated. For example, when there is a positional difference between the region-of-interest image of the current frame and the region-of-interest image of the next frame, the position information may be generated by reflecting the positional difference. However, the inventive concept is not limited thereto, and the position information may be generated based on a positional difference, a motion difference, an image difference, and so on between the region-of-interest image of the current frame and the region-of-interest image of the next frame.

In operation S1220, the display device may store the background image in a buffer (e.g., buffer 210). In operation S1230, the display device may overwrite the region-of-interest image to the buffer based on the position information. The display device may overwrite the region-of-interest image to a region of the background image corresponding to the position information based on the position information. The display device may overwrite the region-of-interest image to a region of interest and accordingly, the background image of the region of interest is erased from the background image and image data of the region-of-interest image is stored in the region of interest. Because the background image and the region-of-interest image may be stored together in one buffer, the number of buffers used in the display device may be reduced, and cost required to produce a display device may be reduced.

In operation S1240, the display device may update at least one of the background image and the region-of-interest image. For example, the display device may update the region-of-interest image. When there is a difference between a region-of-interest image of a current frame (e.g., region-of-interest image RI) and a region-of-interest image of a next frame (e.g., region-of-interest image FRI), the display device may receive the region-of-interest image of the next frame. The display device may update the region-of-interest image by overwriting the region-of-interest image of the next frame to a buffer based on the position information.

As another example, the display device may update the background image. When there is a difference between a background image of a current frame (e.g., background image BI) and a background image of a next frame (e.g., background image FBI), the display device may receive the background image of the next frame. The display device may update the background image by overwriting the background image of the next frame to the buffer based on the position information. The display device may update the background image by overwriting the background image of the next frame to the buffer such that the background image of the next frame is in a region other than the region of interest.

In an example embodiment, the display device may update one of the background image of the current frame and the background image of the next frame to a buffer based on position information. When there is a positional difference between the region-of-interest image of the current frame and the region-of-interest image of the next frame, and when the region-of-interest image of the current frame is updated to the region-of-interest image of the next frame, the existing region-of-interest image corresponding to the region-of-interest image of the current frame needs to be updated to the background image of the current frame or the background image of the next frame. The existing region of interest may be updated to the background image of the current frame or the background image of the next frame based on the position information.

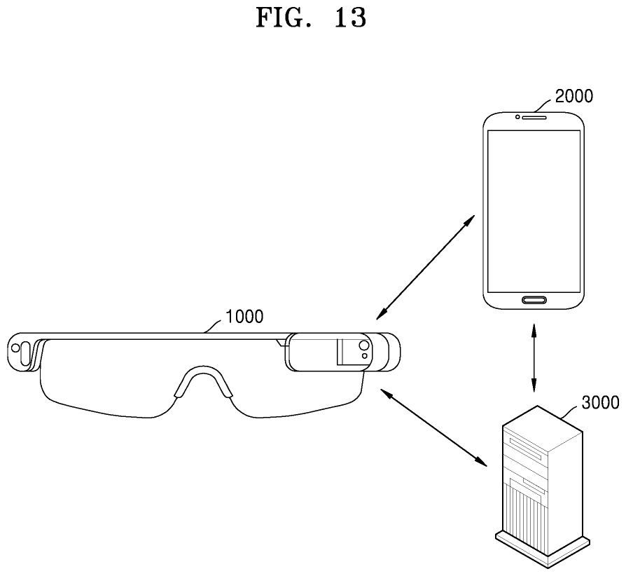

FIG. 13 is a diagram illustrating a wearable device system according to an example embodiment.

Referring to FIG. 13, the wearable device system may include a wearable electronic device 1000, a mobile terminal 2000, and a server 3000. The display device described herein may be included in the wearable electronic device 1000. The wearable device system may be implemented with more components than the components illustrated in FIG. 13 or may be implemented with fewer components than the components illustrated in FIG. 13. For example, the wearable device system may be implemented with the wearable electronic device 1000 and the mobile terminal 2000 or with the wearable electronic device 1000 and the server 3000.

The wearable electronic device 1000 may be communicatively connected to the mobile terminal 2000 or the server 3000. For example, the wearable electronic device 1000 may perform short-range communication with the mobile terminal 2000. For example, the short-range communication may include wireless local area network (LAN) (Wi-Fi), near field communication (NFC), Bluetooth, Bluetooth low energy (BLE), ZigBee, Wi-Fi direct (WFD), ultrawideband (UWB), and so on, but is not limited thereto. In addition, the wearable electronic device 1000 may be connected to the server 3000 through wireless communication or mobile communication.

The mobile terminal 2000 may transmit preset data to the wearable electronic device 1000 or receive preset data from the wearable electronic device 1000. For example, the mobile terminal 2000 may transmit a control command on transmission timing of a background image (e.g., background image BI) and a region-of-interest image (e.g., region-of-interest image RI), a control command on generation of a foveated image, and so on to the wearable electronic device 1000.

In addition, the mobile terminal 2000 may be implemented in various forms. For example, the mobile terminal 2000 described herein may include a mobile phone, a smartphone, a laptop computer, a tablet PC, an electronic book terminal, a digital broadcasting terminal, a personal digital assistant (PDA), a PMP, a navigation, a motion picture experts group (MPEG) audio layer-3 (MP3) player, a digital camera, or so on, but is not limited thereto.

The server 3000 may be a cloud server that manages the wearable electronic device 1000. In addition, the server 3000 may be a contents provider that provides a message instructing control of transmission timing of a background image and a region-of-interest image, a foveated image generation message, and so on.

In an example embodiment, the server 3000 may include an intelligence engine, and the server 3000 may extract a user's region of interest by analyzing the user's line-of-sight pattern (state) or the user's motion pattern (state) through the intelligence engine. In addition to the server 3000, the mobile terminal 2000, which performs short-range communication with or is communicatively connected to the server 3000 or the wearable electronic device 1000, may analyze the user's region of interest.

In addition, the user's region of interest extracted based on the line-of-sight pattern (state) analyzed by the server 3000 may be directly transmitted to the wearable electronic device 1000 or may be transmitted to the wearable electronic device 1000 through the mobile terminal 2000 which performs short-range communication with or is communicatively connected to the wearable electronic device 1000.

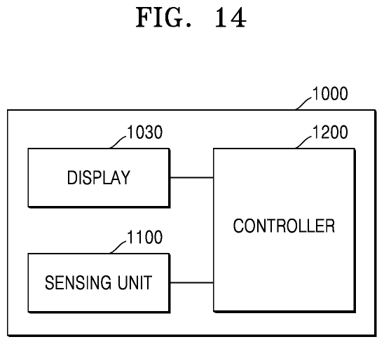

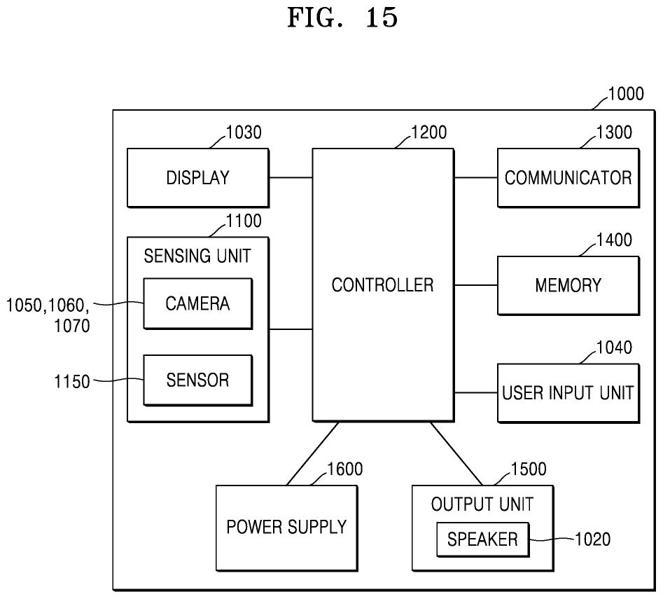

FIGS. 14 and 15 are block diagrams illustrating wearable electronic devices according to example embodiments. Wearable electronic devices 1000 of FIGS. 14 and 15 may correspond to the wearable electronic device 1000 of FIG. 13.

Referring to FIG. 14, the wearable electronic device 1000 according to the example embodiment may include a sensing unit 1100, a controller 1200, and a display 1030. The wearable electronic device 1000 of FIG. 14 may correspond to the display device described with reference to FIG. 1.

In an example embodiment, the display 1030 may correspond to the display panel 300 described with reference to FIG. 1. The display 1030 may display an image to a user based on information processed by the wearable electronic device 1000. The display 1030 may display a foveated image in which a part corresponding to a user's region of interest is implemented in a high resolution and the rest is implemented in a low resolution.

The sensing unit 1100 may acquire information on a user's body or information on a user's gesture. The information on the user's body may include an image of the body, and the information on the user's gesture may include an image of the user's body making a gesture.

In an example embodiment, the controller 1200 may correspond to the processor 100 and the timing controller 200 described with reference to FIG. 1. For example, the controller 1200 may serve as the processor 100 and the timing controller 200. The controller 1200 according to the embodiment may identify a user's region of interest from among a plurality of regions included in an image displayed based on a sensing result of the sensing unit 1100. The controller 1200 may generate a region-of-interest image (e.g., region-of-interest image RI) based on the user's region of interest. The controller 1200 may generate a background image (e.g., background image BI). The controller 1200 may overwrite the region-of-interest image to a buffer (e.g., buffer 210) based on position information (e.g., position information pi). The controller 1200 may update at least one of the background image (e.g., background image BI) and the region-of-interest image (e.g., region-of-interest image RI) in the buffer (e.g., buffer 210).

Referring to FIG. 15, the wearable electronic device 1000 may further include a communicator 1300, a memory 1400, a user input unit 1040, an output unit 1500, and a power supply 1600. According to an example embodiment, the sensing unit 1100 may include a sensor 1150 and at least one of cameras 1050, 1060, and 1070. The various components described above may be connected to each other through a bus.

The controller 1200 may control all operations of the wearable electronic device 1000. For example, the controller 1200 may control the display 1030, the sensing unit 1100, the communicator 1300, the memory 1400, the user input unit 1040, the output unit 1500, and the power supply 1600 by executing programs stored in the memory 1400.

In an example embodiment, the controller 1200 may control the sensing unit 1100 to identify a user's line-of-sight region by using sensing information on the user's body (for example, eyes).

The cameras 1050, 1060, and 1070 may capture images of objects in a real space. The images captured by the cameras 1050, 1060, and 1070 may be moving images or continuous still images. The wearable electronic device 1000 may be, for example, a glasses-shaped device having a communication function and a data processing function, and the camera 1050 that is included in the wearable electronic device 1000 worn by a user and faces the front of the user may capture an image of an object in a real space.

Also, the camera 1060 may capture an image of a user's eye. For example, the camera 1060 that is included in the wearable electronic device 1000 worn by a user and faces the user's face may capture an image of the user's eyes.

Also, the camera 1070 for tracking an eye may capture an image of the user's eye. For example, the camera 1070 for tracking an eye that is included in the wearable electronic device 1000 worn by a user and faces the user's face may track a region of interest by tracking at least one of a head pose, an eyelid, and a pupil of the user.

The sensor 1150 may detect a state of the wearable electronic device 1000 or a state around the wearable electronic device 1000 and transmit the detected information to the controller 1200. For example, the sensor 1150 may acquire a wearing state information on a user that wears the wearable electronic device 1000. For example, the sensor 1150 may include a geomagnetic sensor, an acceleration sensor, a gyroscope sensor, a proximity sensor, an optical sensor, a depth sensor, an infrared sensor, an ultrasonic sensor, and so on.

The communicator 1300 may transmit and receive information necessary for the wearable electronic device 1000 to display an image and adjust the displayed image to and from a device, a peripheral device, or a server.

The memory 1400 may store information necessary for the wearable electronic device 1000 to display an image and generate a foveated image.

The user input unit 1040 may receive a user input for controlling the wearable electronic device 1000. The user input unit 1040 may receive a touch input and a key input for the wearable electronic device 1000.

The power supply 1600 may supply power necessary for an operation of the wearable electronic device 1000 to each component. The power supply 1600 may include a battery (not illustrated) capable of charging power and may include a cable (not illustrated) or a cable port (not illustrated) capable of receiving power from the outside.

The output unit 1500 may output information, which is received from the communicator 1300, processed by the controller 1200, or stored in the memory 1400, in the form of at least one of light, sound, and vibration. For example, the output unit 1500 may include a speaker 1020 that outputs audio data. Also, the speaker 1020 may output sound signals related to functions (for example, call signal reception sound, message reception sound, and notification sound) that are performed by the wearable electronic device 1000.

While the inventive concept has been particularly shown and described with reference to embodiments thereof, it will be understood that various changes in form and details may be made therein without departing from the spirit and scope of the following claims.

What is claimed is:

1. A display device comprising:
a processor configured to generate a region-of-interest image of a current frame based on a background image of the current frame and a line-of-sight region of a user; and
a timing controller configured to output the background image and the region-of-interest image to a display panel,
wherein the timing controller comprises:
a buffer storing at least one of the background image and the region-of-interest image; and
a reception controller configured to overwrite the region-of-interest image to the buffer based on position information of the region-of-interest image in the background image and to update the at least one of the background image and the region-of-interest image in the buffer.

2. The display device of claim 1, wherein the reception controller is configured to overwrite the region-of-interest image to a region corresponding to the position information in the background image based on the position information, in the buffer.

3. The display device of claim 1,
wherein the processor compares the region-of-interest image of the current frame stored in the buffer with a region-of-interest image of a next frame generated to update the region-of-interest image of the current frame,
wherein when there is a difference between the region-of-interest image of the current frame and the region-of-interest image of the next frame, the processor transmits the region-of-interest image of the next frame to the timing controller, and
wherein when there is no difference between the region-of-interest image of the current frame and the region-of-interest image of the next frame, the processor does not transmit the region-of-interest image of the next frame to the timing controller.

4. The display device of claim 3, wherein the reception controller is configured to update the region-of-interest image of the current frame by overwriting the region-of-interest image of the next frame to the buffer based on the position information generated by comparing the region-of-interest image of the current frame and the region-of-interest image of the next frame which are received from the processor.

5. The display device of claim 1,
wherein the processor compares the background image of the current frame stored in the buffer with a background image of a next frame generated to update the background image of the current frame,
wherein when there is a difference between the background image of the current frame and the background image of the next frame, the processor transmits the background image of the next frame to the timing controller, and
wherein when there is no difference between the background image of the current frame and the background image of the next frame, the processor does not transmit the background image of the next frame to the timing controller.

6. The display device of claim 5, wherein the reception controller is configured to update the background image of the current frame by overwriting the background image of the next frame to a region of the buffer, excluding a region corresponding to the region-of-interest image of the current frame from the background image of the current frame, based on the position information.

7. The display device of claim 1, wherein, when there is a difference in position between the region-of-interest image of the current frame stored in the buffer and a region-of-interest image of the next frame generated to update the region-of-interest image of the current frame, the processor transmits, to the timing controller, one of the background image of the current frame and the background image of the next frame generated to update the background image of the current frame, and the position information generated by comparing the region-of-interest image of the current frame with the region-of-interest images of the next frame.

8. The display device of claim 7, wherein the reception controller is configured to update one of the background image of the current frame and the background image of the next frame in the buffer based on the position information.

9. The display device of claim 8, wherein the reception controller is configured to update one of the background image of the current frame and the background image of the next frame to a region of the buffer, excluding a region corresponding to the region-of-interest image of the next frame from the background image of the current frame, based on the position information.

10. The display device of claim 1, wherein the timing controller further comprises a scaler configured to receive a mixing image, in which the background image is mixed with the region-of-interest image, from the buffer, and scale the mixing image to be displayed on the display panel.

11. The display device of claim 1, wherein a time when the background image is updated on the display panel is different from a time when the region-of-interest image is updated on the display panel.

12. The display device of claim 11, wherein the time when the region-of-interest image is updated on the display panel is less than the time when the background image is updated on the display panel.

13. The display device of claim 1, wherein the region-of-interest image is higher in resolution than the background image.

14. A display device comprising:
a processor configured to generate a region-of-interest image of a current frame based on a background image of the current frame and a line-of-sight region of a user;
a timing controller configured to output the background image and the region-of-interest image to a display panel, and
a buffer storing the background image and the region-of-interest image,
wherein the timing controller is configured to:
receive the background image, the region-of-interest image, and position information of the region-of-interest image in the background image from the processor through an interface,
write the background image to the buffer,
based on the position information, write the region-of-interest image to a region of a background image corresponding to the position information, and
update at least one of the background image and the region-of-interest image to the buffer.

15. The display device of claim 14, wherein, when receiving, through the interface, a region-of-interest image of a next frame generated to update the region-of-interest image of the current frame stored in the buffer and the position information generated by comparing the region-of-interest image of the current frame with the region-of-interest image of the next frame, the timing controller updates the region-of-interest image of the current frame to the region-of-interest image of the next frame in the buffer based on the position information.

16. The display device of claim 14, wherein, when receiving, through the interface, a background image of a next frame generated to update the background image of the current frame stored in the buffer, the timing controller updates the background image of the next frame to a region excluding a region corresponding to the region-of-interest image from the background image of the current frame in the buffer based on the position information.

17. The display device of claim 14,
wherein when there is a positional difference between a region-of-interest image of the current frame and a region-of-interest image of a next frame stored in the buffer, the processor transmits, to the timing controller, one of the background image of the current frame and the background image of the next frame generated to update the background image of the current frame, and the position information generated by comparing the region-of-interest image of the current frame with the region-of-interest image of the next frame, and
wherein the timing controller updates one of the background image of the current frame and the background image of the next frame to the buffer based on the position information.

18. The display device of claim 14, wherein the timing controller generates an output image by scaling up a mixing image obtained by mixing together the background image and the region-of-interest image stored in the buffer.

19. The display device of claim 18, wherein the time when the region-of-interest image is updated to the output image is less than the time when the background image is updated to the output image.

20. A wearable electronic device comprising:
at least one sensor;
a processor configured to generate a region-of-interest image based on a background image and a line of sight of a user tracked by using the at least one sensor; and
a timing controller configured to store the background image in a buffer included in the timing controller and overwrite the region-of-interest image to the buffer based on position information of the region-of-interest image in the background image.
